(19) United States
(12) Patent Application Publication
(10) Pub. No.: US 2009/0244645 A1
(43) Pub. Date: Oct. 1, 2009

(54) DOCUMENT PROCESSING DEVICE, DOCUMENT PROCESSING METHOD AND COMPUTER READABLE MEDIUM

(75) Inventors: Hiroshi SHIGEMATSU, Kawasaki-shi (JP); Nana Akimoto, Kawasaki-shi (JP); Junpei Uoshima, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/212,354

(22) Filed: Sep. 17, 2008

(30) Foreign Application Priority Data
Mar. 25, 2008 (JP) 2008-077233

(51) Int. Cl. H04N 1/00

(52) U.S. Cl. 358/440

(57) ABSTRACT

A document processing device includes: a reception section that receives a transmission instruction of a facsimile document from a facsimile transmitting person; an acquirement section that acquires receiving person information including contact information of a receiving person of the facsimile document of the received transmission instruction; a document storage section that stores the facsimile document when a mail address is included in the acquired receiving person information; a mail transmission section that transmits to the mail address included in the receiving person information, a notice mail which informs of the facsimile document being stored; a mail reception section that receives a reply mail to the transmitted notice mail; and a facsimile document transmission section that transmits the facsimile document to a destination specified by the received reply mail.

### CROSS-REFERENCE TO RELATED APPLICATIONS

This application is based on and claims priority under 35 USC 119 from Japanese Patent Application No. 2008-077233 filed Mar. 25, 2008.

### BACKGROUND

1. Technical Field

The present invention relates to a document processing device, a document processing method and a computer readable medium.

2. Related Art

Generally, in case that a facsimile document is transmitted or received between a facsimile transmitter which transmits the facsimile document and a facsimile receiver which receives the facsimile document, a facsimile transmitting person who operates the facsimile transmitter specifies (inputs or selects) a facsimile number which is a destination of the facsimile document, and transmits the facsimile document from the facsimile transmitter. On the other hand, a facsimile receiving person who receives the facsimile document, by a facsimile receiver to which a facsimile number specified by the facsimile transmitting person in the facsimile transmitting time is assigned, prints contents of the facsimile document on paper or displays the contents on a display, thereby to confirm the contents. At this time, in case that a G3 standard which is most widely applied as a facsimile communication standard is utilized, the facsimile receiver for actually receiving the facsimile document is limited to a facsimile receiver to which the facsimile number specified by the facsimile transmitting person in the facsimile transmitting time is assigned.

Therefore, in case that the facsimile receiving person knows previously a facsimile receiver which he desires as a the facsimile document receiving destination, a facsimile number assigned to its facsimile receiver is informed to the facsimile transmitting person in advance before the transmission of the facsimile document, whereby the facsimile receiving person can receive the facsimile document in the desired facsimile receiver. However, before receiving the advance notice from the facsimile receiving person, in case that the facsimile transmitting person has already transmitted the facsimile document to a destination of another facsimile number, the facsimile receiving person must inform the facsimile transmitting person about the desired facsimile number to request retransmission of the facsimile document. Further, in case that the facsimile receiver is a facsimile communication device having an Internet facsimile function, it is necessary to specify a transfer destination of transfer for the received facsimile document to a destination assigned to the facsimile receiver which the facsimile receiving person desires.

### SUMMARY

According to an aspect of the invention, a document processing device includes a reception section, an acquirement section, a document storage section, a mail transmission section, a mail reception section and a facsimile document transmission The reception section receives a transmission instruction of a facsimile document from a facsimile transmitting person. The acquirement section acquires receiving person information including contact information of a receiving person of the facsimile document of the received transmission instruction. The document storage section stores the facsimile document when a mail address is included in the acquired receiving person information. The mail transmission section transmits to the mail address included in the receiving person information, a notice mail which informs of the facsimile document being stored. The mail reception section receives a reply mail to the transmitted notice mail. The facsimile document transmission section transmits the facsimile document to a destination specified by the received reply mail.

### BRIEF DESCRIPTION OF THE DRAWINGS

Exemplary embodiment(s) of the present invention will be described in detail based on the following figures, wherein:

FIG. 1 is a conceptual view showing configuration of a communication system according to an exemplary embodiment of the invention;

FIG. 2 is a block diagram showing functional configuration of a document processing device according to the exemplary embodiment of the invention;

FIG. 3 is a flowchart showing a procedure of processing to be performed upon reception of a transmission instruction of a facsimile document from a facsimile transmitting person, in the document processing device according to the exemplary embodiment of the invention;

FIG. 4 is a diagram showing a sentence example of a notice mail;

FIG. 5 is a flowchart showing a procedure of processing to be performed sequentially after the notice mail transmission, in the document processing device according to the exemplary embodiment of the invention; and

FIG. 6 is a diagram for explaining an example of a computer program, a storage medium storing the computer program and a computer when realizing the functions of document processing device according to the exemplary embodiment of the invention by the computer program.

### DETAILED DESCRIPTION

An exemplary embodiment of the invention will be described below in detail with reference to drawings. A technical scope of the invention is not limited to the exemplary embodiment described below, but includes also exemplary embodiments in which various modifications and improvements are made in a range in which specified advantages obtained by constituent features of the invention and combination of them are derived.

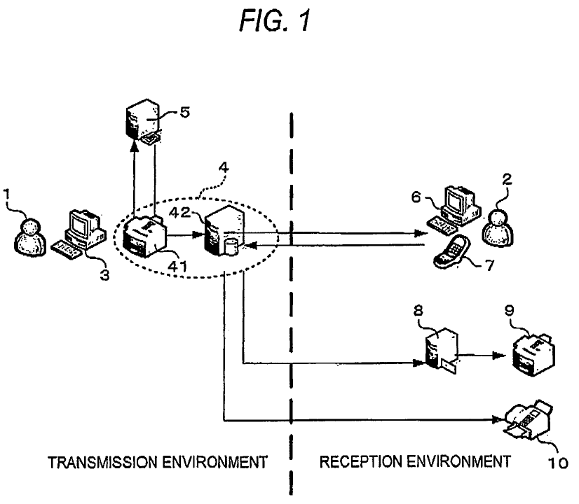

FIG. 1 is a conceptual view showing configuration of a communication system according to an exemplary embodiment of the invention. This communication system is largely divided into a transmission environment on the facsimile document transmitting side, and a reception environment on the facsimile document receiving side. In the transmission environment, a facsimile transmitting person 1 exists, and in the reception environment, a facsimile receiving person 2 exists. Further, in the transmission environment, a terminal device 3, a document processing device 4, and a data server 5 exist; and in the reception environment, a terminal device 6, a portable type telephone (hereinafter referred to as a “portable telephone”) 7, a mail server 8, a facsimile receiver 9 having an Internet facsimile function, and a facsimile receiver 10 having a facsimile function corresponding to a G3 standard. The Internet facsimile function means a function of transmitting or receiving a facsimile document through Internet. The facsimile transmitter and the facsimile receiver each having the Internet facsimile function transmit and receive the facsimile document in an appended state to an electronic mail.

The terminal device 3 is constituted by, for example, a personal computer (hereinafter referred to as “PC”). The terminal device 3 is operated by the facsimile transmitting person 1. The document processing device 4 has, decomposing internal functions of the document processing device 4, both of a function as a multi-function device 41 and a function as a document management server 42. The multi-function device 41 and the document management server 42 constituting the document processing device 4 may be constituted with integral structure or with different body structure (with different structure). Specially, considering transmission of the facsimile document, the document processing device 4 may exist, without having the function as the multi-function device 41, on the network as only the document management server 42. Herein, in order to understand readily the constitution of the document processing device 4, the functions of the document processing device 4 will be explained, divided into the function as the multi-function device 41 and the function as the document management server 42.

The multi-function device 41 is connected through a network (not shown) to both of the terminal device 3 and the data server 5. The multifunction device 41 receives a transmission instruction of a facsimile document from the facsimile transmitting person 1 who operates the terminal device 3. The transmission instruction of the facsimile document may be performed by operating the terminal device 3, or may be performed by facsimile transmitting person's directly operating an operational panel of the multi-function device 41. Further, the multi-function device 41, every time receives the instruction transmission of the facsimile document from the facsimile transmitting person 1, accesses to the data server 5 thereby to make an authentication request of the facsimile transmitting person 1 and an acquirement request of receiving person information regarding the facsimile receiving person 2.

The document management server 42 manages the facsimile document of which the multi-function device 41 has received the transmission instruction from the facsimile transmitting person 1 and various pieces of information indicating its facsimile document. The document management server 42 includes a database function, a function of transmitting and receiving an electronic mail, a function of transmitting a facsimile document by a G3 standard, and an Internet facsimile function. The document management server 42 is connected to Internet and a public line.

The data server 5 is constituted by, for example, an LDAP (Lightweight Directory Access Protocol) server. Herein, as an example, the data server 5 is constituted by an LDAP authentication server having a user authentication function. In the data server 5, a database in which many pieces of information relating to a user (hereinafter referred to as “user information”) have been stored is provided. In this database, the user information in which a name of a user (hereinafter referred to as a “user name”) is associated with contact information of the user is stored for each user. As the contact information, there are stored, for example, a telephone number (a number for a telephone call), a facsimile number (a number for facsimile communication), and a mail address (an electronic mail address). The user name may be stored with a personal name or a corporation name.

Of respective pieces of information included in the exemplified user information, the user name becomes indispensable information when the user information is stored in the database. Regarding the contact information such as the telephone number, the facsimile number, and the mail address, at least one of them is stored in the database in association with the user name. For example, in user information stored with a user name “Taro Fujiyama”, a telephone number, a facsimile number, and a mail address are stored in association with its user name. On the other hand, there can be a case where in user information stored with a user name “Hanako Fujiyama”, only a telephone number is stored in association with the user name.

On the other hand, the terminal device 6 existing in the reception environment is constituted by, for example, a PC, and has a function of transmitting and receiving an electronic mail. The portable telephone 7 is owned by the facsimile receiving person 2, and has a call function and a function of transmitting and receiving an electronic mail. Both of the terminal device 6 and the portable telephone 7 are operated by the facsimile receiving person 2. Further, between the document processing device 4 existing in the transmitting environment, and the terminal device 6 and the portable telephone 7 existing in the reception environment, a mail server for transmitting or receiving an electronic mail exists, which is omitted in FIG. 1.

The mail server 8 is used for delivery (including transfer) and storage of the electronic mail. Herein, the mail server 8 fulfills a function of storing an electronic mail (electronic mail to which a facsimile document is appended) transmitted with a mail address assigned to the facsimile receiver 9 as a specified destination in a mail box prepared correspondingly to the mail address, thereafter fetching the electronic mail from the mail box upon reception of inquiry of the mail from the facsimile receiver 9, and transmitting the electronic mail to the facsimile receiver 9.

The facsimile receiver 9 is constituted by, for example, a multi-function device having a scanner function and a print function in addition to the Internet facsimile function. The facsimile receiver 9, when has received a facsimile document appended to an electronic mail to its own receiver 9 from the mail server 8, or when has received a print instruction of the facsimile document from the facsimile receiving person 2 through a button operation, prints out the facsimile document on paper. The facsimile receiver 10, when has received a facsimile document to its own receiver 10, prints out the facsimile document on paper.

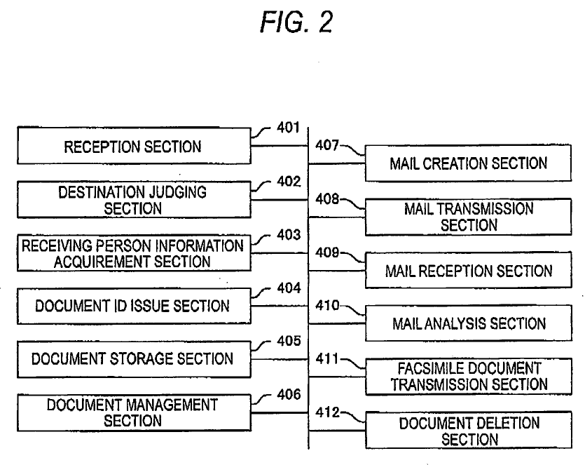

FIG. 2 is a block diagram showing functional configuration of the document processing device 4 according to the exemplary embodiment of the invention. The document processing device 4 includes a reception section 401, a destination judging section 402, a receiving person information acquirement section 403, a document ID issue section 404, a document storage section 405, a document management section 406, a mail creation section 407, a mail transmission section 408, a mail reception section 409, a mail analysis section 410, a facsimile document transmission section 411 and a document deletion section 412.

The reception section 401 receives various instructions including a transmission instruction of the facsimile document from the facsimile transmitting person 1 who operates the terminal device 3 and from the facsimile transmitting person 1 who operates its own device (document processing device 4). The destination judging section 402 judges a destination of the facsimile document of which the transmission instruction has been received by the reception section 401.

The receiving person information acquirement section 403 acquires information of a receiving person who receives the facsimile document of which the transmission instruction has been received by the reception section 401. The document ID issue section 404 issues a document ID for managing the facsimile documents on a document basis. The document ID is unique information (document identifying information) given to each facsimile document, and is issued so that a relation with the facsimile document becomes 1:1.

The document storage section 405 stores, in a document database included in the document processing device 4, a facsimile document satisfying a predetermined condition (of which details will be described later), of the facsimile documents of which the transmission instructions have been received by the reception section 401. The storage of the facsimile document is performed by storing the facsimile document in the document database included in the document processing device 4.

The document management section 406 manages the facsimile document stored by the document storage section 405. The document management section 406 manages the facsimile document by means of a document management table, and deletes information relating to the facsimile document which does not require the management, of the pieces of information stored in the document management table.

The mail creation section 407 creates a notice mail for informing a mail address included in the reception information acquired by the receiving person information acquirement section 403, about the existence of the facsimile document stored by the document storage section 405.

The mail transmission section 408 transmits the notice mail created by the mail creation section 407. The mail reception section 409 receives a reply mail to the notice mail transmitted by the mail transmission section 408. The mail analysis section 410 analyzes contents of the reply mail received by the mail reception section 409.

The facsimile document transmission section 411 performs the transmission of the facsimile document. The transmission of the facsimile document by the facsimile transmission section 411 is performed by a first transmission method based on a G3 standard or a second transmission method based on an Internet facsimile standard. In case that the facsimile communication standard is the G3 standard, a facsimile destination is specified by a facsimile number composed of a numeric string of predetermined figures (generally, 10 figures); and in case that the facsimile communication standard is the Internet facsimile standard, a facsimile destination is specified by a mail address. Therefore, in case that the facsimile destination is specified by a facsimile number, the applicable facsimile communication becomes the G3 standard; and in case that the facsimile destination is specified by a mail address, the applicable facsimile communication becomes the Internet facsimile standard. The document deletion section 412 deletes, from the document database, a facsimile document satisfying a predetermined condition (of which details will be described later), of the facsimile documents stored by the document storage section 405.

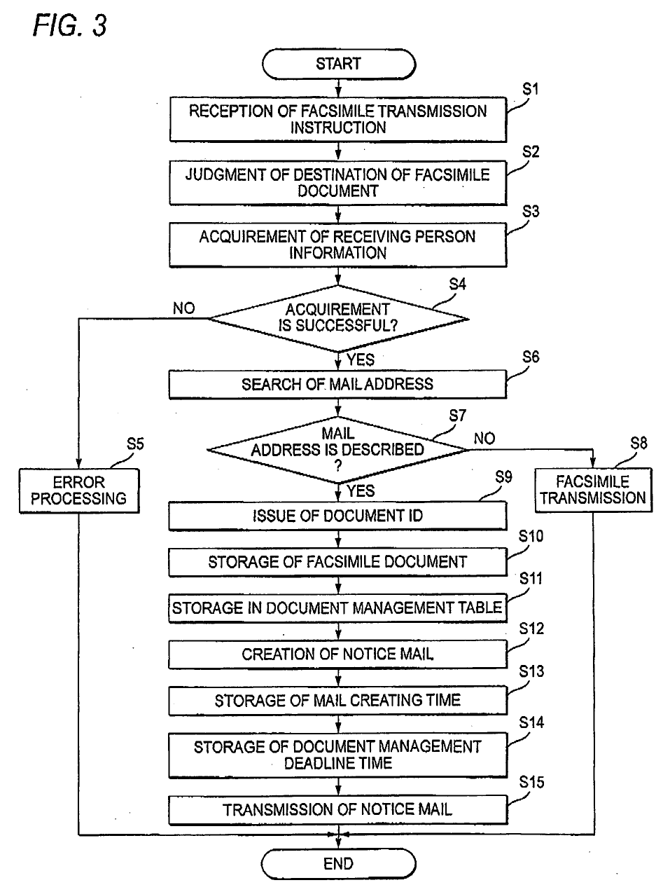

FIG. 3 is a flowchart showing a procedure of processing to be performed upon reception of a transmission instruction of the facsimile document from the facsimile transmitting person 1, in the document processing device 4 according to the exemplary embodiment of the invention. First, when the facsimile transmitting person 1 operates the terminal device 3 or the multi-function device 41 of the document processing device 4 (through a key operation or a button operation) to give a transmission instruction of the facsimile document, this transmission instruction is received by the reception section 401 (step S1). Herein, as an example of the communication standard of the facsimile document of which the transmission instruction is received from the facsimile transmitting person 1, the G3 standard is used.

Next, a destination of the facsimile document of which the transmission instruction has been received in the step S1 is judged by the destination judging section 402 (step S2). The destination of the facsimile document is specified by a facsimile number. Therefore, the destination judging section 402 judges the facsimile number specified based on the transmission instruction of the facsimile document as the destination of the facsimile document. The specifying of the facsimile number is performed by the facsimile transmitting person 1 who operates the terminal device 3 or the multi-function device 41.

Next, on the basis of the destination information judged in the step S2, an acquirement request for receiving person information is transmitted to the data server 5. In case that the data server 5 has transmitted the receiving person information as a response to this acquirement request, the receiving person information is received (step S3). This processing is performed by the receiving person information acquirement section 403. The receiving person information means, when the user information stored in the database of the data server 5 are searched with the destination information judged in the above step S2 as a search key, user information including the same information as the search key and stored in the database.

Therefore, when the facsimile number specified by the transmission instruction of the facsimile document has been judged as a destination, and the data server 5 has searched the database with this destination information as a search key, in case that user information including the same facsimile number as the facsimile number of the search key has been stored in the database, the user information including its facsimile number are acquired as receiving person information. In this case, the user information acquired from the data server 5 includes at least a user name and a facsimile number. Further, when the receiving person name specified by the transmission instruction of the facsimile document has been judged as a destination, and the data server 5 has searched the database with this destination information as a search key, in case that user information including the same user name as the receiving person name of the search key has been stored in the database, the user information including its user name are acquired as receiving person information. In this case, the user information acquired from the data server 5 includes at least a user name and contact information. Further, the data server 5, in case that the user information including the same information as the search key information has not been stored in the database, transmits, as a reply, a message indicating that the receiving person information corresponding to an acquirement request does not exist, in place of the receiving person information. At this time, together with the acquirement request of the receiving person information, an authentication request of the transmitting person may be performed. The authentication request of the transmitting person, when the transmission instruction of the facsimile document is received by the multi-function device 41 of the document processing device 4, is performed by importing the transmitting person information specified by the facsimile transmitting person 1 and transmits the data server 5 a request for authentication processing based on the transmitting person information. The data server 5 which has received this authentication request confirms whether the user information including the transmitting person information transmitted from the multi-function device 41 has been stored in the database or not. In case that the user information has been stored, the data server 5 notifies, as an authentication result, the multi-function device 41 about the already-authenticated transmitting person information. Hereby, a history indicating who is the transmitting person giving the transmission instruction of the facsimile document remains in the document processing device 4.

Further, in the database of the data server 5, there is stored, as described before, the user information associating the contact information such as a telephone number, a facsimile number, and a mail address with the user name. Therefore, for example, in case that the facsimile transmitting person 1 transmits a facsimile document to the facsimile receiver 10 installed at a house of the facsimile receiving person 2 or at his place of work, even if the transmitting person 1 does not know the facsimile number of the facsimile receiver 10, as long as user information with a name of the facsimile receiving person 2 (a receiving person name) as a user name has been stored in the database of the data server 5, and the facsimile number associated with the facsimile receiving person 2 has been stored in the user information, the facsimile transmitting person 1, by only specifying the receiving person name as a destination of the facsimile document, can acquire the facsimile number associated with the receiving person name from the data server 5 and transmit the facsimile document.

Accordingly, the destination of the facsimile document can be specified not only by the facsimile number but also by the receiving person name of the facsimile document and by both of the facsimile number and the receiving person name. In case that the destination of the facsimile document is specified by the receiving person name, the database in the data server 5 is searched with the receiving person name as a search key. In case that user information including information coincident with the search key exists in the database, its user information is acquired as the receiving person information. Further, the destination of the facsimile document is specified by both of the facsimile number and the receiving person name, the database in the data server 5 is searched with them as search keys. In case that user information including information coincident with the search key exists in the database, its user information is acquired as the receiving person information.

Specifically, in case that the destination information judged in the above step S2 is a receiving person name of “Taro Fujiyama”, and the user information stored with a user name coincident with this receiving person name exists in the database of the data server 5, its user information is acquired as receiving person information. In this time, in case that a telephone number, a facsimile number, and a mail address have been stored in association with the user name of “Taro Fujiyama” in the database of the data server 5, their information are acquired together with the user name as the receiving person information.

To the contrary, in case that the destination information judged in the above step S2 is a receiving person name of “Hanako Fujiyama”, and the user information stored with a user name coincident with this receiving person name exists in the database of the data server 5, its user information is acquired as receiving person information. In this time, in case that only a telephone number has been stored in association with the user name of “Hanako Fujiyama” in the database of the data server 5, its information is acquired together with the user name as the receiving person information.

Next, the receiving person information acquirement section 403 judges whether the acquirement of the receiving person information has succeeded or not in the above step S3 (step S4). Success or failure of the acquirement of the receiving person information is judged as follows. Namely, in case that the receiving person information including the facsimile number has been received from the data server 5 in the processing of the step S3, the acquirement of the receiving person information is judged to be successful. Further, in case that the receiving person information not including the facsimile number has been received from the data server 5 in the processing of the step S3, or in case that a message indicating that the corresponding receiving person information does not exist has been received, the acquirement of the receiving person information is judged to be unsuccessful. In case that the acquirement of the receiving person information is judged to be unsuccessful, error processing for notifying the facsimile transmitting person 1 about the fact that facsimile transmission is unsuccessful (display of an error message on a display of the terminal device 3 or the multi-function device 41) is performed (step S5), and thereafter a series of processing relating to the facsimile transmission ends. Further, in case that the acquirement of the receiving person information has been judged to be unsuccessful in the step S4 because the destination specified by the transmission instruction of the facsimile document is the facsimile number, and the user information including a facsimile number coincident with its facsimile number does not exist in the database of the data server 5, the transmission of the facsimile document to the destination of the specified facsimile number may be performed in place of the above error processing, and thereafter a series of processing may end.

On the other hand, in case that that the acquirement of the receiving person information has been judged to be successful, the document management section 406 searches whether a mail address is included together with a facsimile number in its receiving person information (step S6). In result of the search, in case that the mail address is not included (in case of No in a step S7), the facsimile document is subjected to facsimile transmission to a destination specified by the facsimile number included in the receiving person information by the G3 standard (step S8), and thereafter a series of processing ends. The transmission of the facsimile document is performed by the facsimile document transmission section 411.

To the contrary, in case that the mail address is included in the receiving person information (in case of Yes in a step S7), a document ID for managing the facsimile document on a document basis is issued (step S9). The issue of the document ID is performed by the document ID issue section 404.

Next, the facsimile document for which the document ID is to be issued in the step S9 is stored in the document database (step S10). The storage of the facsimile document in the document database is performed by the document storage section 405. Next, given information is stored in the document management table (step S11). The storage in the document management table is performed by the document management section 406. The document management table is stored in the document database thereby to be held. In the document management table, information for managing the facsimile document stored in the document data base is stored. Specifically, for example, the aforesaid document ID, storage location information of facsimile document, a storage period of facsimile document, the allowable number by which the transmission of the facsimile document is allowed, a reception waiting period of a replay mail from the facsimile receiving person, and a forced transmission flag are stored for each facsimile document as the above “given information”.

The storage location information of the facsimile document is information indicating where the facsimile document is stored in the document database. For example, the storage location information is stored with memory address information for specifying a memory area in the document database where the facsimile document is stored.

The storage period of the facsimile document section a retention period of the facsimile document stored in the document database. The storage period of the facsimile document is set to, for example, a week in default.

The allowable number by which the transmission of the facsimile document is allowed defines the number by which the facsimile document stored in the document database is transmitted to the facsimile receiving person. For example, in case of a facsimile document of which the allowable number is set to one, the transmission of its facsimile document is allowed only once, and the transmission from the next time is inhibited. Further, in case of a facsimile document of which the allowable number is set to five, the transmission of its facsimile document is allowed five times, and the transmission from the next time is inhibited. Further, in case of a facsimile document of which the allowable number is set without limit (without an upper limit), the transmission of its facsimile document is allowed without limit within the above storage period of the facsimile document. This allowable number is set without limit in default.

The reception waiting period section a period for waiting a replay mail to the notice mail after transmitting a notice mail for notifying the receiving person of the facsimile document about the existence of the facsimile document stored in the document database to the receiving person. This reception waiting period is set to, for example, three days in default.

The forced transmission flag is a flag for judging whether the facsimile transmission is forcedly performed in case that the facsimile transmitting person has not received the replay mail within the reception waiting period. This forced transmission flag is set to ON in default.

Regarding these storage period, allowable number, reception waiting period, and faced transmission flag, when the facsimile transmitting person 1 gives an instruction of transmission of the facsimile document, the facsimile transmitting person 1 may give an instruction of change of them together with the transmission instruction. The change instruction from the facsimile transmitting person 1 is received by the reception section 401 together with the transmission instruction of the facsimile document. Especially, in case that there is no change instruction from the facsimile transmitting person 1, these pieces of given information are set, remaining default.

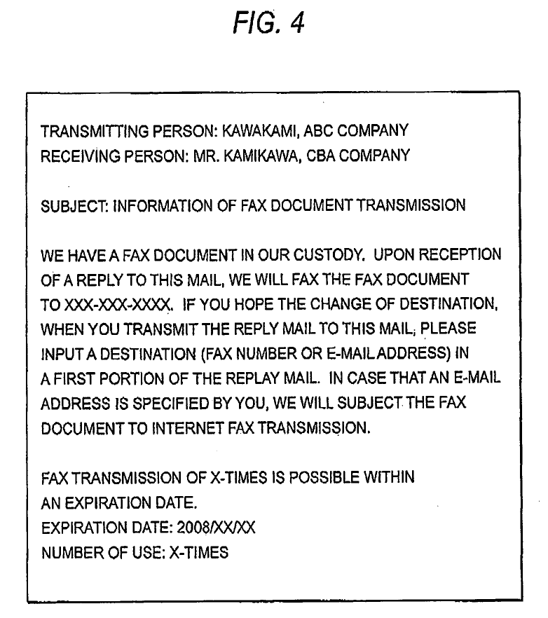

Next, a notice mail to the facsimile receiving person 2 is created by the mail creation section 407 (step S12). This notice mail becomes an electronic mail for informing the facsimile receiving person about the existence of the facsimile document. The notice mail may be created as follows: one kind or plural kinds of templates of an electronic mail in which a description style has been previously determined are prepared, and necessary information is described in portions (blank space) other than fixed characters in this electronic mail. As an example, to a “subject” of the notice mail, fixed characters of, for example, “notice of facsimile document transmission” are assigned; and in a “destination” of the notice mail, the mail address extracted from the receiving person information by the search in the step S6 is described. Further, in a “body” of the notice mail, a mail sentence as shown in FIG. 4 is described. In the shown mail example, in a “transmitting person”, transmitting person information specified by the facsimile transmitting person 1 himself on the basis of the transmission instruction of the facsimile document, and the transmitting person information acquired as the authentication result in the data server 5 are reflected; and in a “destination”, the transmitting person information acquired from the data server 5 is reflected. Further, in a “body” of the notice mail, notice sentences for receiving the facsimile document are described; and in their sentences, operational information for destination change, and “expiration date” and “number of utilization” of facsimile transmission is expressed. The expiration date of the facsimile transmission is described in accordance with the above reception waiting period stored in the document management table of the document database, and the number of utilization of the facsimile transmission is described in accordance with the above allowable number. For example, in case that the storage period is set to a week in default, the expiration date of the mail transmission is described as the date after a week; and in case that the allowable number is set to five, the number of utilization of the mail transmission is described as five times.

After the notice mail has been created in such the description style, the mail creating time is stored in the above document management table (step S13), and thereafter the time when the above reception waiting period of the facsimile document has passed from the mail creating time is stored as reception deadline time in the document management table (step S14). The storage of each time in the document management stable is performed by the document management section 406. Thereafter, after the notice mail has been transmitted (step S15), a series of processing ends. The transmission of the notice mail is performed by the mail transmission section 408. Though the document management deadline time is determined from the notice mail creating time here, the document management deadline time may be determined from the notice mail transmitting time. Further, in case that the mail address specified as the destination of the notice mail is a mail address assigned to the terminal device 6 of the facsimile receiving person 2, the facsimile receiving person 2 receives the notice mail transmitted from the document processing device 4 through the terminal device 6. Further, in case that the mail address specified as the destination of the notice mail is a mail address assigned to the portable telephone 7 of the facsimile receiving person 2, the facsimile receiving person 2 receives the notice mail transmitted from the document processing device 4 through the portable telephone 7.

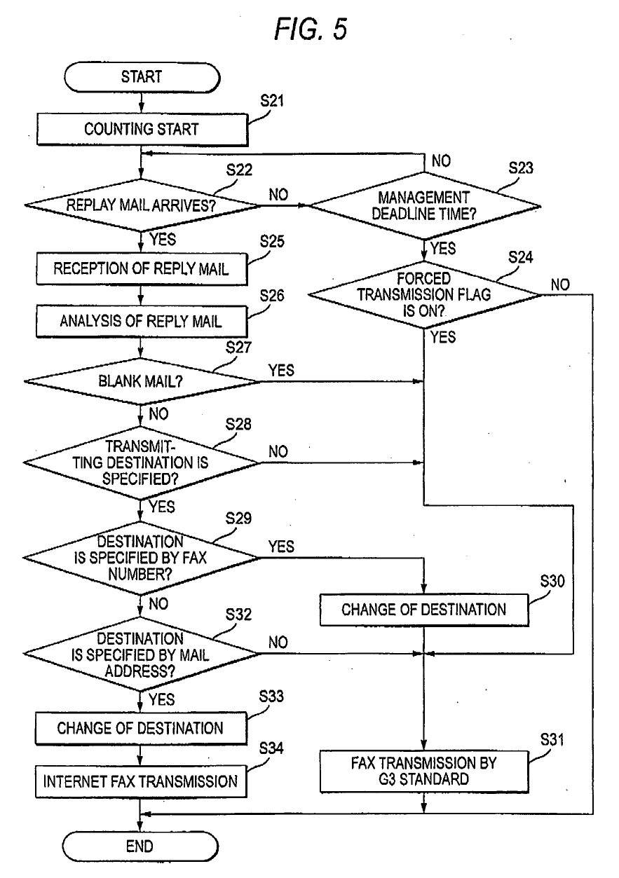

FIG. 5 is a flowchart showing a procedure of processing to be performed sequentially after the notice mail transmission, in the document processing device 4 according to the exemplary embodiment of the invention. First, after the notice mail has been transmitted in accordance with the aforesaid processing, time counting is started by means of a timer (step S21). The time counting is performed by the document management section 406. Next, whether the reply mail has reached or not is confirmed by the mail reception section 409 (step S22). If the replay mail has not reached, whether the present time arrives the reception deadline time stored in the step S14 or not is confirmed by the document management section 406 (Step S23). Whether the reply mail has reached or not is judged by whether an electronic mail having the mail address specified as the destination in the notice mail as a mail address of the transmitting side has reached or not.

In case that the reception deadline time has come in a state where the reply mail does not reach, whether the aforesaid forced transmission flag is set to ON or not is confirmed by the document management section 406 (step S24). In case that the forced transmission flag is set to ON, the processing proceeds to a step S31, and the facsimile document is subjected to facsimile transmission to the destination (facsimile number) specified by the transmission instruction of the facsimile document from the facsimile transmitting person 1 by the G3 standard. The transmission processing of the facsimile document in the step S31 is performed by the facsimile document transmitting section 411. Further, in case that the forced transmission flag is set to OFF, a series of processing ends without transmitting the facsimile document.

To the contrary, in case that the replay mail has reached before the document management deadline time comes, the replay mail is received by the mail reception section 409 (step S25), and thereafter analysis of the replay mail is performed by the mail analysis section 410 (step S26). In result of the analysis of the replay mail, in case that the replay is a blank mail, the processing proceeds from a step S27 to the step S31. In case that contents of the replay mail are substantially the same as those of the original notice mail (quotation marks such as indent and the like are ignored), it is judged in a step S28 that the facsimile transmitting destination is not specified, and the processing proceeds to the step S31. In the step S31, the facsimile document is subjected to facsimile transmission to the destination (facsimile number) specified by the transmission instruction of the facsimile document from the facsimile transmitting person 1 by the G3 standard.

Further, in result of the analysis of the reply mail, in case that a destination of the facsimile transmission has been specified in a form of addition to the contents of the notice mail, whether its destination is specified by a facsimile number or not is confirmed by the facsimile document transmission section 411 (step S29). In the notice mail received through the terminal device 6 or the portable telephone 7 by the facsimile receiving person 2, a notice sentence prompting an input of a destination in a first (head) portion of the replay mail in case that the destination of the facsimile document is changed is described. Therefore, by extracting a character string described in the first portion of the replay mail, information necessary for the destination change is obtained.

In case that the destination specified by the replay mail is a facsimile number, processing of changing the transmission destination of the facsimile document is performed (step S30), and thereafter processing proceeds to the step S31. The destination change of the facsimile document is performed by the facsimile document transmission section 411. In this case, in the step S31, not to the destination (facsimile number) specified by the transmission instruction of the facsimile document from the facsimile transmitting person 1, but to the destination (facsimile number) specified by the replay mail from the facsimile receiving person 2, the facsimile document is subjected to the facsimile transmission by the G3 standard.

Further, in case that the destination specified by the replay mail is not a facsimile number but a mail address, processing of changing the facsimile document transmitting destination from the facsimile number to the mail address is performed (step S33), thereafter the transmission method of the facsimile document is changed from the method based of the G3 standard to the method based of the Internet facsimile standard, and the facsimile document is attached to an electronic mail and subjected to Internet facsimile transmission in a step S34. All of the destination change of the facsimile document, the change of the facsimile document transmitting method, and the Internet facsimile transmission of the facsimile document are performed by the facsimile document transmitting section 411.

Whether the destination specified by the reply mail is the facsimile number or not is judged by whether the character string specified as the destination applies to the form of facsimile number (a numerical string of predetermined figures) or not. Similarly, whether the destination specified by the reply mail is the mail address or not is judged by whether the character string specified as the destination applies to the form of mail address.

Further, in case that the destination specified by the replay mail is neither a facsimile number nor a mail address, that is, in case that the character string described as the destination is in conformity with neither the form of facsimile number nor the form of mail address, the processing shifts from a step S32 to the step S31, and the facsimile document is subjected to the facsimile transmission to the destination (facsimile number) specified by the transmission instruction of the facsimile document from the facsimile transmitting person 1 by the G3 standard.

In the above series of processing, the facsimile document transmission section 411 transmits the facsimile document within the allowable number stored in the document management table. For example, in case that the allowable number stored in the document management table is set without limit, the facsimile document is transmitted any number of times within the storage period of the facsimile document correspondingly to a transmission request (reception of the reply mail) from the facsimile receiving person 2. Further, in case that the allowable number stored in the document management table is set to one, the transmission of the facsimile document to the facsimile receiving person 2 is allowed only once.

Further, the document deletion section 405, separately from the above series of processing, deletes the facsimile document in which the storage period stored in the document management table has elapsed, of facsimile documents stored in the document database. Further, the document management section 406 deletes, from the document management table, information (document ID, storage location information, storage period, allowable number, reception waiting period, and forced transmission flag) on the facsimile document deleted by the document deletion section 405. The confirmation of whether or not the storage period of the facsimile document has elapsed may be performed individually for each facsimile document at a predetermined interval, or may be performed in a lump for all the facsimile documents stored in the document database at a predetermined interval.

Though it is assumed in the exemplary embodiment that the communication standard of the facsimile document receiving the transmission instruction from the facsimile transmitting person 1 is the G3 standard, this communication standard including the communication standard of the facsimile transmission applied in the step S31 is not limited to the G3 standard, but may be a G4 standard.

Further, the communication standard of the facsimile document receiving the transmission instruction from the facsimile transmitting person 1 may be the Internet facsimile standard. In this case, as an information storage form of the user information stored in the database of the data server 5, a first type mail address for Internet facsimile, and a second type mail address for PC or portable terminal are stored respectively as different contact information; and the existence of the second type mail address (for PC or portable terminal) is judged in the step S7. Further, in case that the facsimile document destination specified by the transmission instruction from the facsimile transmitting person 1 is a mail address, and the facsimile document destination specified by the replay mail from the facsimile receiving person 2 is a mail address different from the former address, the mail address of the facsimile document destination is changed to the latter address, and the facsimile document is transmitted by a transmission method based on the Internet facsimile standard applied to the changed destination. To the contrary, in case that the facsimile document destination specified by the transmission instruction from the facsimile transmitting person 1 is a mail address, and the facsimile document destination specified by the replay mail from the facsimile receiving person 2 is a facsimile number, the destination of the facsimile document is changed from the mail address to the facsimile number, the transmission method of the facsimile document is changed from the transmission method based on the Internet facsimile standard to the transmission method based on the G3 standard (or G4 standard), and thereafter the facsimile document is transmitted.

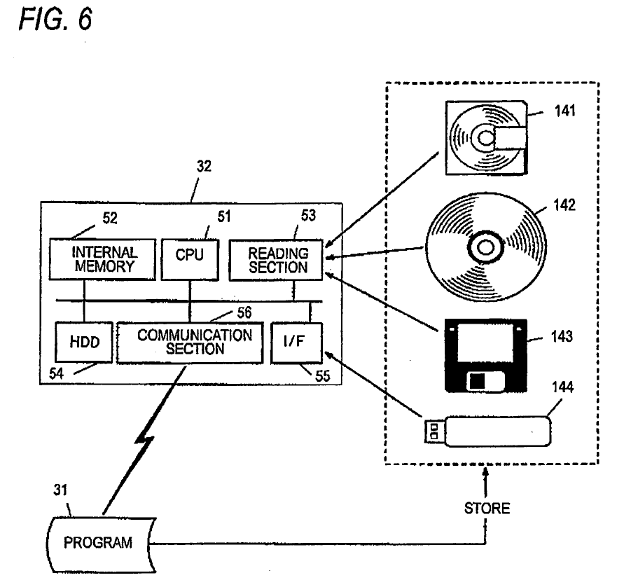

FIG. 6 is a diagram for explaining an example of a computer program, a storage medium storing the computer program and a computer when realizing the functions of document processing device in the exemplary embodiment by the computer program. In the figure, 31 denotes the program, 32 denotes the computer (document processing device), 141 denotes a magneto-optical disc, 142 denotes an optical disc, 143 denotes a magnetic disc, 144 denotes a memory, 51 denotes a CPU, 52 denotes an internal memory, 53 denotes a reading section, 54 denotes a hard disc drive (HDD), 55 denotes an interface (I/F) and 56 denotes a communication section.

A part or all of the respective functions described in the exemplary embodiment may be realized by the program 31 executable by the computer. In this case, the program 31, data used by the program and data of the conversion coefficients may be stored in a storage medium which can be read by the computer. The storage medium is a medium which can cause the reading section 53, provided as the hardware resource at the computer, the changing state of energy such as magnetism, light, electricity in accordance with the described contents of the program to thereby transmit the contents of the program and data to the reading section 53 in the format of the corresponding signal. For example, the storage medium is one of the magneto-optical disc 141, the optical disc 142 (including a CD, a DVD etc.), the magnetic disc 143, the memory 144 (including an IC card, a memory card etc.) etc. Of course, each of these storage mediums is not limited to a portable type.

The part or all of the respective functions of the aforesaid embodiment may be realized in a manner that the program 31 is stored in these storage mediums, then these storage mediums are inserted into the reading section 53 or the interface 55 of the computer 32, for example, then the program 31 is read from the computer and stored in the internal memory 52 or the hard disc drive 54, and the CPU 51 executes the program 31. Alternatively, the part or all of the respective functions of the aforesaid embodiment and the modified examples of the invention may be realized in a manner that the program 31 is transferred to the computer 32 via a network etc., then the computer 32 receives the program 31 at the communication section 56 to store into the internal memory 52 or the hard disc drive 54, and the CPU 51 executes the program 31.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing device comprising:
a reception section that receives a transmission instruction of a facsimile document from a facsimile transmitting person;
an acquirement section that acquires receiving person information including contact information of a receiving person of the facsimile document of the received transmission instruction;
a document storage section that stores the facsimile document when a mail address is included in the acquired receiving person information;
a mail transmission section that transmits to the mail address included in the receiving person information, a notice mail which informs of the facsimile document being stored;
a mail reception section that receives a reply mail to the transmitted notice mail; and
a facsimile document transmission section that transmits the facsimile document to a destination specified by the received reply mail.

2. The document processing device according to claim 1,
wherein the facsimile document transmission section changes, when the destination specified by the reply mail is different from the destination specified by the transmission instruction, the destination of the facsimile document and transmits the facsimile document.

3. The document processing device according to claim 1,
wherein the facsimile document transmission section changes, when a communication standard applied to the destination specified by the reply mail is different from a communication standard applied to the destination specified by the transmission instruction, the destination of the facsimile document and a transmission method thereof, and transmits the facsimile document.

4. The document processing device according to claim 1,
wherein the reception section receives, from the facsimile transmitting person, together with the transmission instruction of the facsimile document, an instruction of a storage period of the facsimile document, and
the document processing device further comprises: a document deletion section that deletes the stored facsimile document of which the storage period has elapsed.

5. The document processing device according to claim 1, wherein:
the reception section receives, from the facsimile transmitting person, together with the transmission instruction of the facsimile document, an instruction of the allowable number by which transmission of the facsimile document is allowed; and
the facsimile document transmission section transmits the facsimile document within the allowable number.

6. The document processing device according to claim 1, wherein
the reception section receives, from the facsimile transmitting person, together with the transmission instruction of the facsimile document, an instruction of a reception waiting period of the reply mail; and
the facsimile document transmitting section, when the mail reception section does not received the replay mail even when the reception waiting period has elapsed, transmits the facsimile document which is stored by the document storage section and of which the reception waiting period has elapsed, to the destination specified by the transmission instruction of the facsimile document from the facsimile transmitting person.

7. A document processing method comprising:
receiving a transmission instruction of a facsimile document from a facsimile transmitting person;
acquiring receiving person information including contact information of a receiving person of the facsimile document of the received transmission instruction;
storing the facsimile document when a mail address is included in the acquired receiving person information;
transmitting to the mail address included in the receiving person information, a notice mail which informs of the facsimile document being stored;
receiving a reply mail to the transmitted notice mail; and
transmitting the facsimile document to a destination specified by the received reply mail.

8. The document processing device according to claim 7, further comprising:
changing, when the destination specified by the reply mail is different from the destination specified by the transmission instruction, the destination of the facsimile document and transmits the facsimile document.

9. A computer readable medium storing a program causing a computer to execute a process for a facsimile communication, the process comprising:
receiving a transmission instruction of a facsimile document from a facsimile transmitting person;
acquiring receiving person information including contact information of a receiving person of the facsimile document of the received transmission instruction;
storing the facsimile document when a mail address is included in the acquired receiving person information;
transmitting to the mail address included in the receiving person information, a notice mail which informs of the facsimile document being stored;
receiving a reply mail to the transmitted notice mail; and
transmitting the facsimile document to a destination specified by the received reply mail.

10. The computer readable medium according to claim 9, further comprising:
changing, when the destination specified by the reply mail is different from the destination specified by the transmission instruction, the destination of the facsimile document and transmits the facsimile document.
